(19) United States
(12) Patent Application Publication
(10) Pub. No.: US 2021/0274971 A1
(43) Pub. Date: Sep. 9, 2021

(54) SELF-CONTAINED SINGLE USE FUEL SYSTEM FOR IMPROVED AIRFLOW AND EASY CLEAN UP

(71) Applicant: THE CLOROX COMPANY, Oakland, CA (US)

(72) Inventors: Sarah L. Snider, Pleasanton, CA (US); Stephen S. Fisher, Pleasanton, CA (US); Jeremy Thuerk, Pleasanton, CA (US); Cecilia V. Melby, Pleasanton, CA (US); Ketaki Malaviya, Pleasanton, CA (US); Donald K. Swatling, Pleasanton, CA (US)

(21) Appl. No.: 17/186,532

(22) Filed: Feb. 26, 2021

Related U.S. Application Data
(60) Provisional application No. 62/985,366, filed on Mar. 5, 2020.

(51) Int. Cl. A47J 37/07; F24C 1/16; A47J 36/02; C10L 5/32

(52) U.S. Cl. CPC A47J 37/0768; F24C 1/16; C10L 2270/08; A47J 37/0786; C10L 5/32; A47J 36/022

(57) ABSTRACT

A self-contained system for grilling including a non-combustible tray, a mesh insert within the tray, defining an air-flow portion below the insert, and a fuel portion above the insert for supporting fuel (e.g., charcoal briquets), with the fuel suspended above the air-flow portion. A plurality of holes may or may not be provided through a lower portion of the tray (e.g., in a lower portion of the sidewall of the tray) to draw combustion air into the air flow portion, below the mesh insert. The system may pre-arrange the fuel in the tray during manufacture, so the user is not required to spread or even touch the briquets, or may be for use with fuel provided by a user. Clean up is very simple, as the entire system can be discarded after a single use, once cooled, as the ash is automatically collected in the bottom of the tray.

### CROSS-REFERENCE TO RELATED APPLICATIONS

This application claims the benefit of and priority to U.S. Provisional Patent Application No. 62/985,366 filed Mar. 5, 2020, which is herein incorporated by reference in its entirety.

### BACKGROUND OF THE INVENTION

### 1. The Field of the Invention

The present invention relates to devices for use with charcoal fuel heating materials. Specifically, the invention relates to devices for simplifying use and clean up of charcoal in cooking (e.g., grilling).

### 2. Background and Relevant Art

Charcoal heating materials, such as charcoal briquets, are commonly used for cooking food. Foods cooked with charcoal can have a unique flavor and have wide appeal. Conventional charcoal briquets generally provide a slow-burning fuel with a high BTU output.

One of the shortcomings of conventional charcoal briquets is that the briquets can be difficult to ignite and may not continue to burn, even after they appear to have been ignited. To address this problem, lighter fluid may be sprayed onto the briquets by the user immediately prior to use, or may be applied during manufacture to provide “instant light” briquets.

In addition to the difficulty in lighting conventional charcoal briquets, once ignited, conventional charcoal briquets typically must complete an initial “ignition phase,” during which visible ash forms over a majority of the briquet surface before they are suitable for cooking. Once past the ignition phase, the briquets burn with an intense heat throughout a “burn phase” during which a consumer can use the briquets for cooking. Unfortunately, the ignition phase of conventional briquets often requires considerable time. As such, there exists a continuing need for ways of reducing the “time to cooking readiness”, while providing a lengthy period thereafter during which food may be grilled on such briquets.

### BRIEF SUMMARY

The present disclosure is directed to systems and methods for grilling. For example, an exemplary system may include an exterior tray formed from a non-combustible material (e.g., metallic foil), a mesh insert disposed within the interior of the tray, defining an air-flow portion below the mesh insert and a fuel portion above the mesh insert, for supporting fuel (e.g., charcoal briquets), with the fuel suspended above the air-flow portion. A solid fuel (e.g., charcoal briquets) can be provided pre-packaged, e.g., already in the fuel portion of the tray, supported on the mesh insert (e.g., so that no spreading or even touching of the charcoal is required by the user). Alternatively the fuel can be provided separately, e.g., by the user.

In an embodiment, a plurality of air flow holes can be provided through a lower portion of the tray, where the holes are configured to draw combustion air into the air-flow portion of the tray, below the mesh insert (and below the fuel), although Applicant has discovered (somewhat surprisingly) that such holes may not be needed to achieve the desired quick ignition of the charcoal or other solid fuel, and an extended burn time during which cooking over such solid fuel can be conducted. Thus, in an embodiment, no such holes may be provided. In any case, the described configuration including the mesh insert that divides the exterior tray into a lower air-flow portion and an upper portion which supports the fuel provides for efficient generally circular air flow, as air is pulled into the bottom of the tray (whether holes are present or not), and rises up through the mesh and charcoal or other fuel to support combustion thereof, and rises upwards out of the tray, while new fresh air is continuously drawn in along the bottom of the tray.

While various existing systems are also available, one advantage of the present system is its inexpensive construction (e.g., metallic foil tray and flexible or bendable metallic wire mesh insert), allowing it to be configured for single use, and disposed of after such a single use. Various existing systems often include more complex components (e.g., components formed from durable non-combustible materials, or more expensive thermally insulative materials, or require netting or similar containment mechanisms over charcoal briquets, etc). The present system is very simple, and does not require such components, allowing it to be provided inexpensively, and on a disposable basis. Other alternative existing systems often are formed from combustible components, which do not offer the advantage of easy clean up afforded by the present configurations. For example, in the present systems, the non-combustible tray serves to collect the ash resulting from the single use, after which the entire system can be disposed of after it has cooled. While disposability after a single use can be a significant benefit, it will of course be appreciated that a user could use the system again, e.g., by refilling the fuel portion with new fuel (e.g., new charcoal briquets).

Further features and advantages of embodiments of the present disclosure will become apparent to those of ordinary skill in the art in view of the detailed description of preferred embodiments below.

### BRIEF DESCRIPTION OF THE DRAWINGS

To further clarify the above and other advantages and features of the present disclosure, a more particular description will be rendered by reference to specific embodiments thereof which are illustrated in the drawings. It is appreciated that these drawings depict only typical embodiments and are therefore not to be considered limiting. Embodiments of the disclosure will be described and explained with additional specificity and detail through the use of the accompanying drawings.

FIG. 1 is an exploded top perspective view of an exemplary self-contained system providing improved air-flow and simplified clean up, according to the present invention.

FIG. 2 is a top perspective assembled view of the system of FIG. 1, without any charcoal briquets.

FIG. 3 is a top perspective assembled view of the system of FIG. 1, with randomly oriented charcoal briquets.

FIG. 3A is a cross-sectional view through the system of FIG. 1.

FIG. 4 is a top view of the system of FIG. 2.

FIG. 5 is a top view of the system of FIG. 3, with randomly oriented charcoal briquets.

FIG. 6 is front view of the system of FIG. 1, the rear view being identical.

FIG. 7 is a first side view of the system of FIG. 1, the opposite side view being identical.

FIG. 8 is a top perspective view of an alternative system similar to that of FIG. 3, but in which the charcoal briquets are oriented vertically, in rows.

FIG. 9 is a top view of the system of FIG. 8.

FIG. 10 is a top perspective view similar to that of FIG. 3, with a food grate positioned thereover.

FIG. 11 shows burn curves for exemplary configurations, illustrating advantages of inclusion of the mesh insert.

FIG. 12 shows additional burn curves for exemplary configurations, comparing an embodiment including holes in the exterior tray as compared to a similar embodiment, but without such holes.

### DETAILED DESCRIPTION

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising,” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “solid fuel” includes one, two or more such materials.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. A stated value should therefore be interpreted broadly enough to encompass values that are at least close enough to the stated value to perform a desired function or achieve a desired result, and/or values that round to the stated value. The stated values include at least the variation to be expected in a typical manufacturing process, and may include values that are within 10%, within 5%, within 1%, etc. of a stated value. Furthermore, where used, the terms “substantially”, “similarly”, “about” or “approximately” represent an amount or state close to the stated amount or state that still performs a desired function or achieves a desired result. For example, the term “substantially” “about” or “approximately” may refer to an amount that is within 10% of, within 5% of, or within 1% of, a stated amount or value.

Some ranges may be disclosed herein. Additional ranges may be defined between any values disclosed herein as being exemplary of a particular parameter. All such ranges are contemplated and within the scope of the present disclosure.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

Implementations of the present invention are described herein primarily with reference to “charcoal” materials such as “charcoal” briquets. A fuel charcoal material (e.g., shaped as a briquet) typically includes char and/or coal as one might infer from the name.

As used herein, a briquet refers to such a charcoal material that is sized and shaped for use as a combustible material for cooking. The size and weight of a briquet may vary widely. Typical charcoal briquet dimensions may range from about 2 cm by about 2 cm by about 1 cm (e.g., about 4 cm³) to about 10 cm by about 10 cm by about 5 cm (e.g., 500 cm³). The weight of such briquets may vary from less than 10 grams to about 1000 grams. A typical briquet may measure about 4.5 cm by about 3.8 cm by about 2.5 cm (e.g., about 40 cm³) and weigh about 20 to about 40 grams. Exemplary briquets and charcoal materials are sold by Applicant under the trademark KINGSFORD, and an example of such briquets is shown in Applicant's U.S. Pat. No. D517,005, herein incorporated by reference in its entirety.

### II. Introduction

The present disclosure is directed to self-contained systems, e.g., for use with charcoal materials or other solid fuel for grilling food, which do not necessarily require the use of a separate grill, as the system provides an enclosure that can be used for such grilling, without the need for a separate (e.g., often expensive) grill into which the charcoal or other solid fuel is typically placed.

In an embodiment, the system advantageously includes a plurality of charcoal briquets or other solid fuel prepackaged during manufacture, with the other components of the system, so that the user is not required to spread charcoal briquets or other solid fuel over the grill, or to even touch the briquets or other fuel at all (which can be dirty, resulting in charcoal or other residue being deposited on the users hands). By way of example, the system may include a unit dose of charcoal briquets or other solid fuel already provided in the tray of the system, for use therewith. Because the briquets or other solid fuel is already provided with the system, this also eliminates guesswork on the part of the user to determine how many briquets or other solid fuel should be used for a particular usage event, etc. In another embodiment, the system need not include the solid fuel provided with the remainder of the system. For example, charcoal briquets or other solid fuel may be provided separately, e.g., purchased separately, provided by the user.

By way of example, an exemplary system can include an exterior tray formed from a non-combustible material (e.g., metallic foil), and a mesh insert (e.g., a flexible or bendable metallic wire mesh) positioned or positionable within the interior of the tray. The mesh insert defines an air-flow portion below the mesh insert, and a fuel portion above the mesh insert for supporting charcoal briquets or other fuel thereon, with the fuel suspended above the air-flow portion of the tray. A solid fuel (e.g., charcoal briquets) can be provided pre-packaged in the fuel portion of the tray, e.g., on the mesh insert. Alternatively, such fuel can be provided separately, e.g., by the user. In an embodiment, the tray can include a plurality of air-flow holes through a lower portion of the sidewalls of the tray, configured to draw combustion air into the air-flow portion of the tray, below the mesh insert, although as will be shown hereafter, such holes are optional, and need not be provided.

### III. Exemplary Systems and Methods of Use

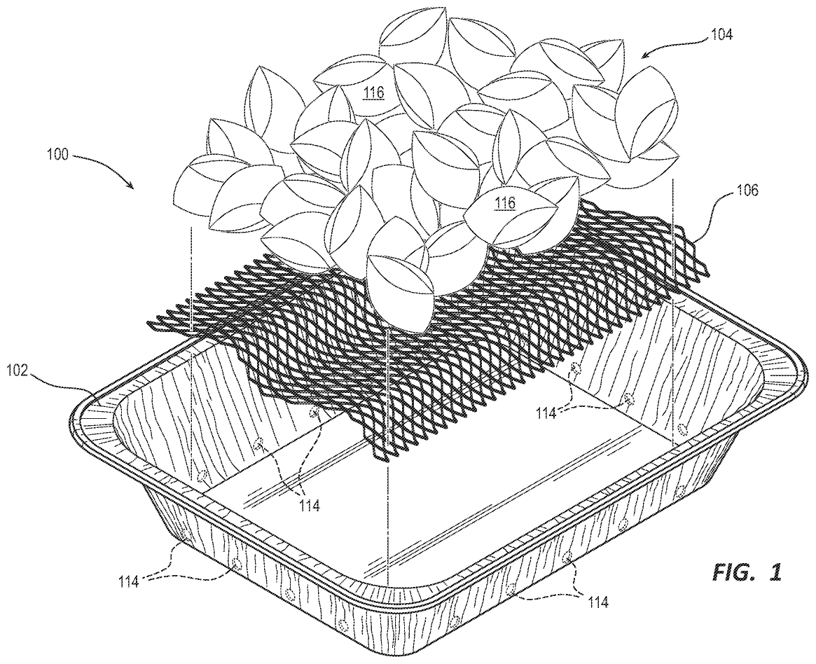

The Figures illustrate exemplary embodiments of how the system can be constructed. For example, as shown in FIG. 1, the system 100 includes a tray 102, e.g., formed from a metallic foil material, or other non-combustible material. Where the tray 102 is formed from an inexpensive metallic foil material (e.g., no more than about 3 mm, 2 mm, or 1 mm thick metal foil), it can be inexpensively provided, so that the entire system can be designed for single use, after which it is simply disposed of Such an embodiment may provide the charcoal briquets 104 or other fuel pre-packaged already in position where it will be combusted, so that the user is not required to spread the briquets 104, or even touch them. Alternatively, the charcoal material or other solid fuel (e.g., pellets, etc.) could be provided separately, and positioned within the tray 102 by the user. In any case, the ash generated upon combustion of the charcoal or other fuel 104 is advantageously automatically captured in the bottom of the tray 102, as it falls through the wire mesh of the insert 106, from the briquets or other solid fuel 104 supported on the top side of the mesh insert 106, into the closed bottom of the tray 102.

While an inexpensive configuration may be preferred in at least some embodiments, in other embodiments, it is contemplated that the tray 102 could be more durable, e.g., formed from a thicker non-combustible material (e.g., metal, or even a ceramic), intended for reuse, where a user may insert “cartridges” of the charcoal or other fuel material 104 into the tray 102, for each individual use. In such a reusable embodiment, the mesh insert 106 could be also be a durable component (e.g., formed from a thicker, more durable material than a simple thin wire mesh, such as a thicker perforated metal tray, or thicker metallic mesh). Alternatively, the mesh insert could be disposable, intended for single use, so as to be discarded along with the ash generated from each use. In an embodiment, the wire mesh or other insert material is inexpensive, so as to be disposable after a single use.

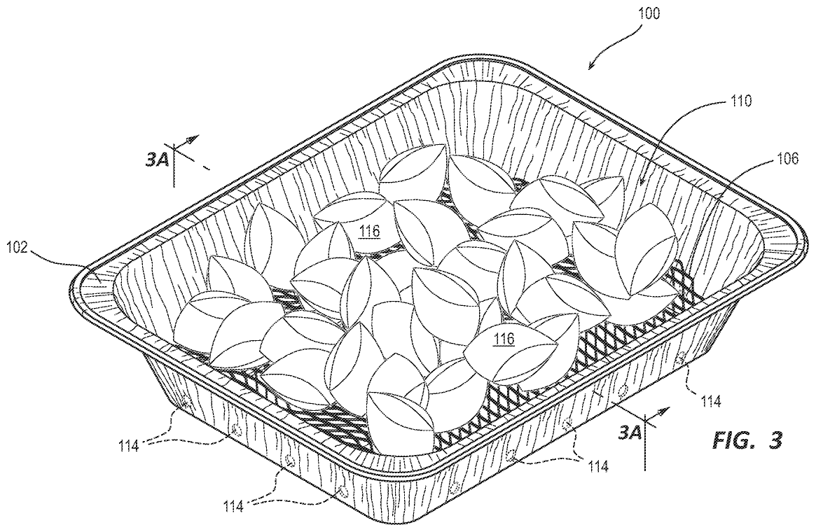

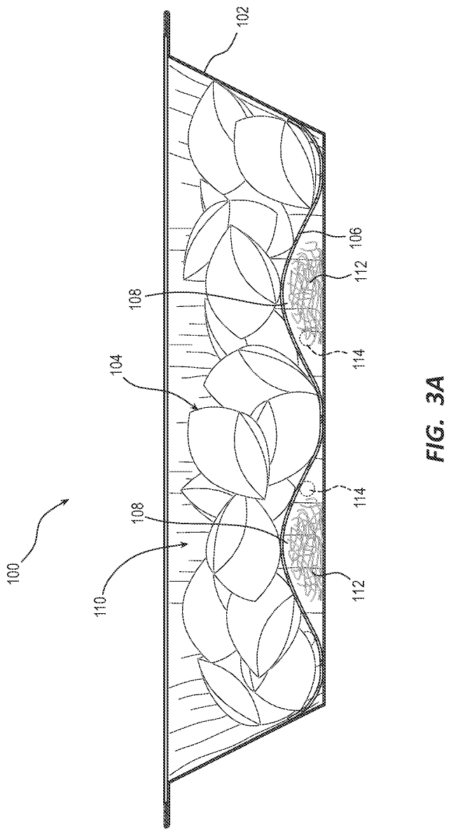

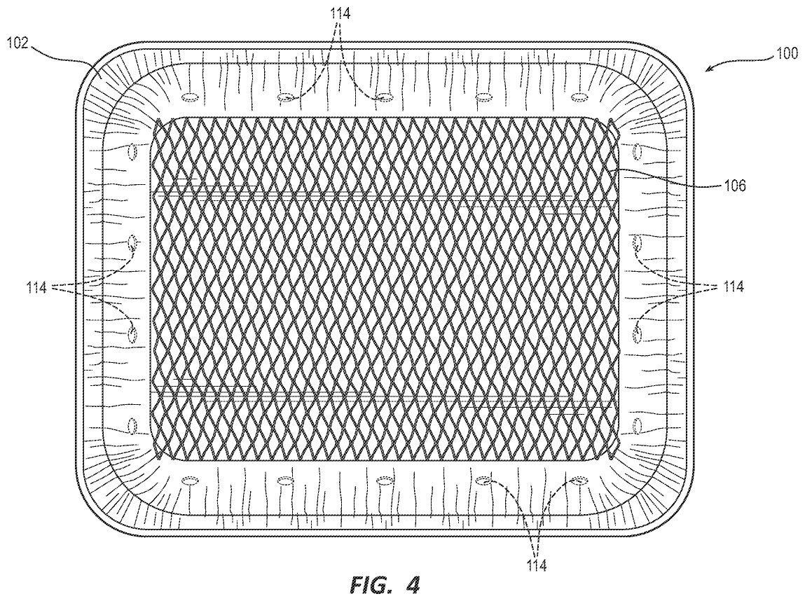

As perhaps best shown in the cross-sectional view of FIG. 3A, the combination of the tray 102 and the mesh insert 106 provide a divided configuration, where an air-flow portion 108 of the tray 102 is defined below the mesh insert 106 (and in which no briquets or other fuel 104 is provided), and a fuel portion 110 is provided above the mesh insert, for holding and supporting the briquets or other fuel 104, where the briquets 104 are suspended above the air-flow portion 108. Suspension of the briquets 104 above the lower air-flow portion 108 of the system is important, as it provides plenty of combustion air that can be drawn from below the fuel portion 110, up into the briquets 104, to support their combustion. The mesh insert 106 may be selectively removable relative to the tray 102, or may be fixed in place, so as to not be removable from the tray 102.

The described configuration also allows a kindling material 112 (e.g., resin soaked paper, wood, cardboard, paper or other shavings, etc.) to be positioned (e.g., prepackaged therein) in the air-flow portion 108 of the system 100, to facilitate easier lighting of the briquets 104 or other fuel positioned on top of the mesh insert 106.

The tray 102 may further include a plurality of holes 114 (e.g., of any desired geometry, such as circles, ovals, elongate slits, etc.) formed through the sidewalls of the tray 102, to better facilitate pulling of fresh combustion air, e.g., as a result of convection, into the air-flow portion 108 of the tray 102, below the mesh insert 106. Such holes 114 may also provide a route by which the user may initially ignite a kindling material 112 initially provided within the air-flow portion 108. The holes 114 may be of the same or different sizes and/or shapes. For example, relatively larger holes may be provided to facilitate a user inserting a match or other flame through such hole, into the air-flow portion 108 to ignite a kindling material 112, or instant light charcoal. A plurality of relatively smaller sized holes may also be provided, e.g., simply for air flow. That said, Applicant has discovered, somewhat surprisingly, that holes are not particularly needed for delivery of sufficient combustion air in order to achieve relatively quick “time to cooking readiness”, with an extended burn time during which the charcoal or other solid fuel can be used for grilling food. For example, as shown below in the Examples, it was found that there may be no significant difference in such performance characteristics, whether holes are present or not.

In an embodiment, the system may be lit at two locations substantially simultaneously, e.g., at two opposed corners of a rectangular tray shaped device 100 as shown, or two opposed sides of a circular tray, etc. The tray itself may assume any of various configurations, e.g., circular, rectangular, square, oval, etc., and may have length, width and depth dimensions that vary. By way of example, the length may be from 12 to 24 inches, the width may be from 12 to 24 inches, and the depth may be from 2 to 12 inches, or from 3 to 10 inches, or from 4 to 8 inches.

In an embodiment, the mesh insert 106 may be supported above the bottom of the tray 102 by the mechanical integrity of the mesh insert itself, or by attachment of the mesh insert 106 to the tray itself (e.g., spanning the mesh insert across the tray, part way up the sidewall of the tray 102). In another embodiment, supports may be provided below the mesh insert 106 to ensure that the mesh insert 106 does not collapse into the bottom of the tray 102 under the weight of the charcoal briquets or other fuel 104 loaded onto the top of the mesh insert 106, as it is advantageous to ensure that the charcoal briquets or other fuel 104 remains suspended above the bottom of the tray 102, with an air-flow portion 108 underneath the suspended fuel 104, to ensure that efficient combustion of the briquets or other fuel occurs during use.

By way of example, the height of the air-flow portion 108 provided under the mesh insert 106 may average at least 0.5 inch, such as 0.5 inch to 3 inches. This is not to say that the mesh insert 106 cannot approach closer than 0.5 inch to the bottom of the tray 102, or in fact contact the tray 102 at some locations. For example, in the illustrated embodiments, the mesh insert 106 is shown to have an undulating wave pattern (e.g., with 2 wave “peaks” across the width of the tray 102). The “trough” of such an undulating wave pattern may contact, or nearly contact the bottom of the tray 102 (see FIG. 3A), but in any case, there is still a significant air-flow portion 108 provided beneath the mesh insert 106, across most of the tray 102, to allow combustion air to be pulled into the air-flow portion 108, and then up through the briquets or other fuel 104 located on the top of the mesh insert 106.

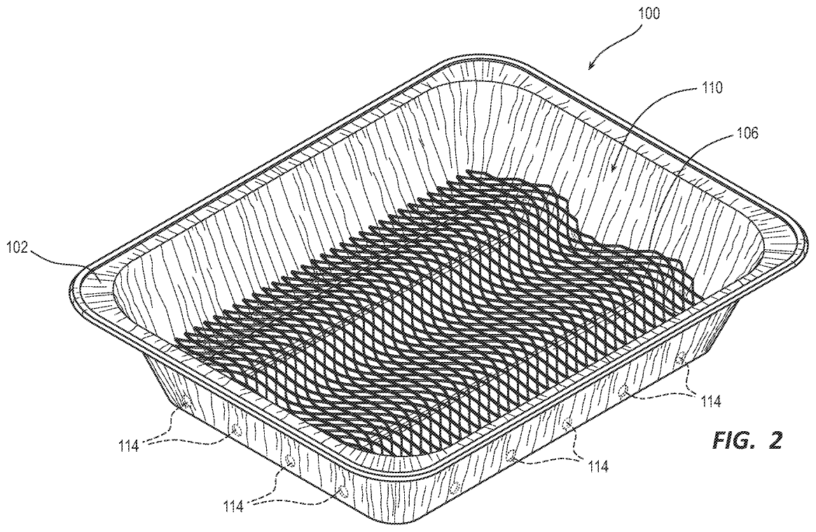

The mesh may be non-planar, e.g., in any of various configurations, such as defining a curved surface, an accordion surface, or an undulating waved surface on which the charcoal briquets are supported. While FIGS. 1-2 show the wave “peak” running generally parallel to the length of the tray 102, it will be apparent that the wave peak could run perpendicular, or other transverse relationship relative to the tray length (or the tray width), such that the illustrated configurations are merely exemplary. In an embodiment, the mesh insert 106 may be a wire mesh material, as shown. It will be apparent that numerous configurations are possible with respect to the mesh insert.

Inclusion of such an air-flow portion 108 not only aids in improving the speed of combustion (and reducing the time to achieve “time to cooking readiness”), but is particularly advantageous in embodiments where the charcoal briquets 104 are dosed with lighter fluid (e.g., instant light briquets). For example, inclusion of such an air-flow portion 108 ensures that any such lighter fluid impregnated in the briquets is consumed before the “time to cooking readiness” is achieved. This is important to avoid any such lighter fluid from negatively impacting the flavor imparted to the food being grilled.

As ash is generated from combustion of the suspended briquets, the ash falls through the mesh insert 106, into the closed bottom of the tray 102, where it is collected, and can eventually be disposed of after use.

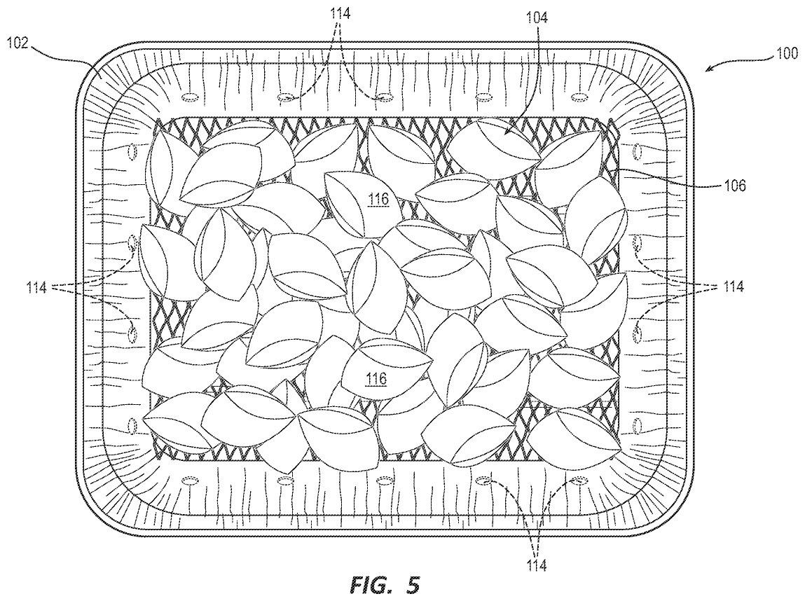

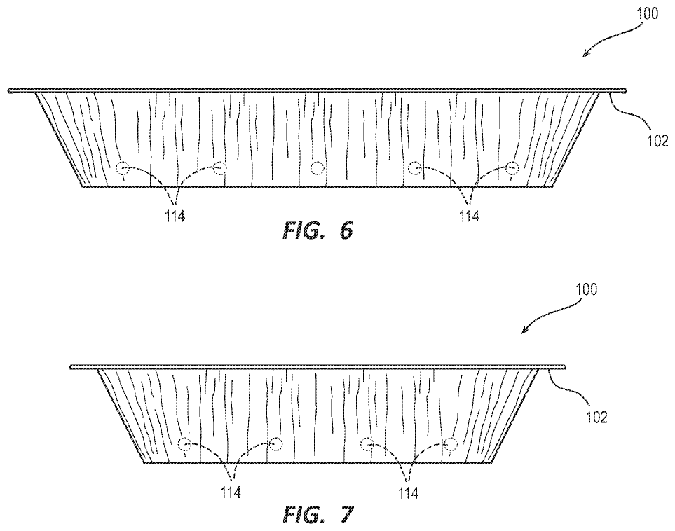

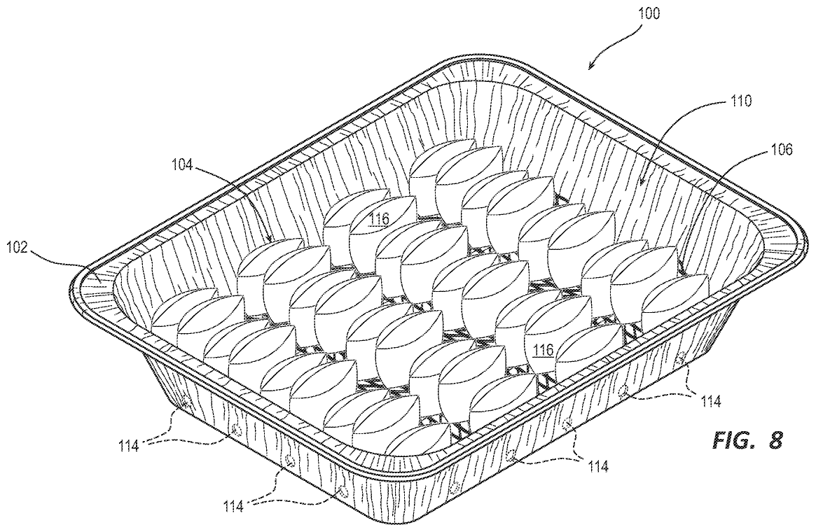

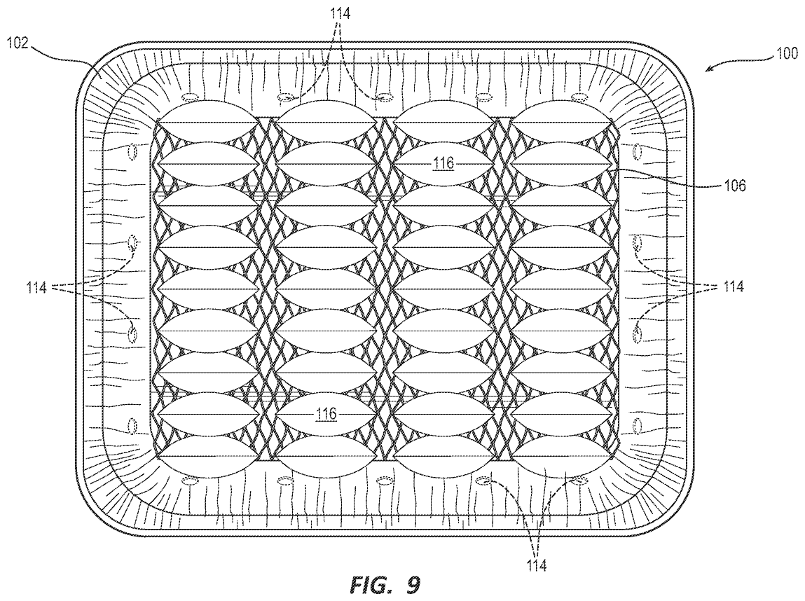

The Figures further illustrate how charcoal briquets or other solid fuel may be positioned in the tray to have various configurations. For example, in an embodiment, the briquets 104 may simply be randomly piled within the fuel portion 110 of the tray 102, suspended above the bottom of the tray (supported on the mesh insert 106). FIGS. 1, 3, and 5 illustrate such a configuration. In another embodiment, the briquets 104 can be arranged in an ordered pattern (e.g., all vertically oriented “up”, positioned face to face, in rows (e.g., 3-6 rows) of briquets, running across the width (or the length) of the tray 102. FIGS. 8 and 9 illustrate a non-limiting example of such a configuration. In any case, where desired, one or more “starter briquets” 116 can be dispersed among the charcoal briquets.

The briquets 104 or other solid fuel could be packaged within a bag or similar enclosure, which is combustible (e.g., so as to be fully consumed during use), so that the bag or similar enclosure ignites, thereby igniting the charcoal briquets stored therein. Such bag or similar enclosure can simply be placed or already provided on the mesh insert 106 of the system 100, for ignition (either lighting the bag or lighting any provided kindling material 112 in the air-flow portion 108 of the tray 102, therebeneath).

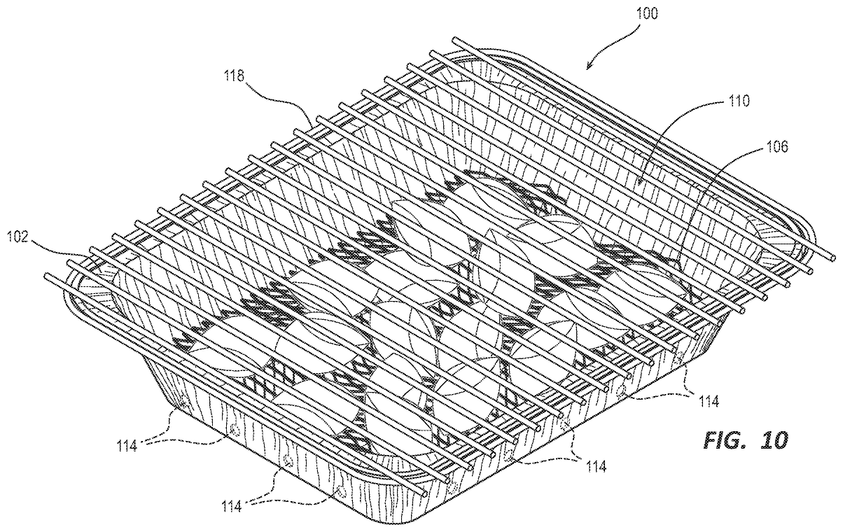

In an embodiment, as shown in FIG. 10, a grate 118 may be provided, e.g., configured for placement over the top of the tray 102 for grilling food on the grate 118, so that the user is not required to provide any other grate for supporting the food. Such a grate 118 will typically be formed of metal, e.g., higher gauge, so as to be more rigid and sturdy than the flexible or bendable mesh insert 106, which is also typically metallic.

The system including separated fuel portions 108 and air-flow portions 110 provides for quick “time to cooking readiness”, i.e., the time required for the briquets to be ashed over to the standard degree (e.g., 50%). By way of example, the described configurations can achieve a “time to cooking readiness” of less than 19 minutes, less than 18 minutes, less than 17 minutes, less than 16 minutes, less than 15 minutes, such as from 12-14 minutes. Such results are significant, impressive, and advantageous. For example, using conventional grilling configurations, with the same charcoal material, typically results in a time to cooking readiness of about 20 minutes. The examples described below achieved such results within less than 19 minutes, less than 18 minutes, or even less than 15 minutes, e.g., from 12 to 14 minutes.

This is particularly advantageous as one of the drawbacks of grilling with charcoal is the time that is required after lighting for the charcoal to be ready for use to cook with. Any reduction in that time is very helpful, and the reductions achieved using the present self-contained systems are significant.

### IV. Examples

Prototypes of the various self-contained systems described herein were tested to evaluate the speed at which they achieve “time to cooking readiness”, as well as other operating characteristics.

### Example 1

Example 1 was configured as a self-contained system as shown in the Figures, and included a metallic foil tray, with a wire mesh insert including an undulating wave pattern. The wire mesh insert was shaped to provide 2 such wave “peaks”. 3 pounds of KINGSFORD ORIGINAL charcoal briquets (not dosed with any lighter fluid) were loaded as a random pile into the tray, on top of the wire mesh insert including the undulating wave pattern. Although the wire mesh insert is flexible or bendable, allowing one to alter its overall shape (e.g., from undulating to some other shape), it is sufficiently rigid to retain the undulating shape with the charcoal briquets loaded thereon. The foil tray included a plurality of holes in the lower portion of the sidewall, providing air-flow into the air-flow portion of the tray, beneath the mesh insert. The air-flow portion was initially provided with 2 strips of resin coated paper extending along the length of the tray, as a kindling material. Four “TUMBLEWEED” fire-starters (e.g., available from Frontier) were also placed with the resin coated paper, as additional kindling material.

Ends of the resin coated paper, (e.g., extending out the top of the tray) were ignited at 1-2 points along one side, at the top of the container. The same configuration was tested over 6 burns, and the results averaged. The tested configuration of Example 1 provided a time to cooking readiness of 18.5 minutes, a peak temperature of 572° F., and a total cooking time (period of time during which temperature is sufficient to cook, e.g., 380° F.) after reaching “time to cooking readiness” of 57.5 minutes. It was observed that the lighting from the top was difficult, as the flames typically do not have a tendency to migrate down, into the air-flow portion. The “time to cooking readiness” would likely be further reduced, if the configuration were lit directly below, in the air-flow portion of the tray.

### Example 2

Example 2 was configured as a self-contained system as shown in the Figures, and included a metallic foil tray, with a wire mesh insert including the same undulating wave pattern as Example 1. 3.3 pounds of KINGSFORD MATCH LIGHT charcoal briquets (dosed with lighter fluid) were loaded as a random pile into the tray, on top of the wire mesh insert including the undulating wave pattern. As in Example 1, the foil tray can include a plurality of holes in the lower portion of the sidewall, providing air-flow into the air-flow portion of the tray, beneath the mesh insert. The air-flow portion was not loaded with any kindling material.

The instant light briquets were ignited at 2 opposite corners of the container, at the top of the container. The same configuration was tested over 6 burns, and the results averaged. The tested configuration of Example 2 provided a time to cooking readiness of 14.2 minutes, a peak temperature of 568° F., and a total cooking time (period of time during which temperature is sufficient to cook) after reaching “time to cooking readiness” of 59.3 minutes.

### Example 3

Example 3 was configured as a self-contained system as shown in the Figures, and included a metallic foil tray, with a wire mesh insert similar to that of Example 1. 1.8 to 2 lbs of KINGSFORD MATCH LIGHT charcoal briquets (dosed with lighter fluid) were arranged vertically, in 4 rows across the width of the tray, with 8-9 briquets per row, on top of the wire mesh insert (e.g., similar to FIGS. 8-9). As in Example 1, the foil tray may include a plurality of holes in the lower portion of the sidewall, providing air-flow into the air-flow portion of the tray, beneath the mesh insert. The air-flow portion was not loaded with any kindling material.

The instant light briquets were ignited at 2 opposite corners of the container, at the top of the container. The tested configuration of Example 3 provided a time to cooking readiness of 12 minutes, a peak temperature of 543° F., and a total cooking time (period of time during which temperature is sufficient to cook) after reaching “time to cooking readiness” of 26 minutes. The reduced total cooking time as compared to Examples 1-2 is likely due to the reduction in the weight of charcoal employed (e.g., 2 lbs vs. 3 lbs).

### Example 4

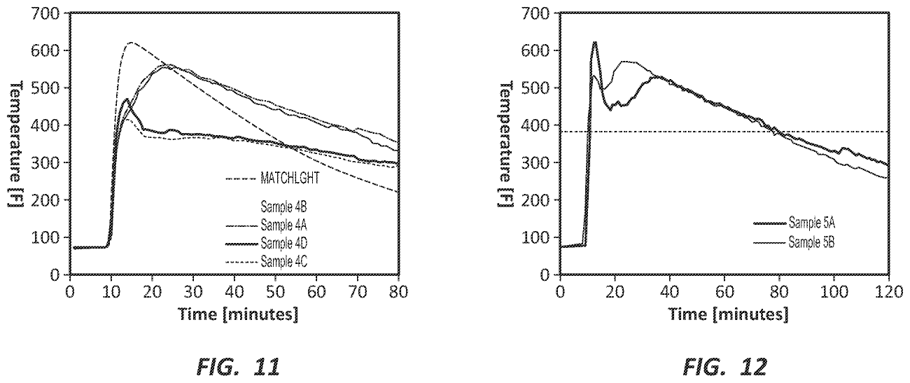

Example 4 was conducted to show the effect of the mesh insert. Samples 4A and 4B of Example 4 each included a metallic foil tray, with a wire mesh insert similar to that of Example 1. Each included 3 pounds of KINGSFORD MATCH LIGHT charcoal briquets (pre-dosed with lighter fluid) loaded as a random pile into the tray, on top of the wire mesh insert including the undulating wave pattern. The foil tray of sample 4A included a total of 18 holes, each about 1 cm in diameter, positioned around the lower portion of the sidewall, providing air-flow into the air-flow portion of the tray, beneath the mesh insert. Sample 4B was similar, but included a total of 22-24 holes, each about 1 cm in diameter, positioned around the lower portion of the sidewall. A comparison of samples 4A and 4B thus illustrate any difference associated with inclusion of more holes and/or more total hole surface area. The instant light briquets were ignited and evaluated. The results are shown in FIG. 11.

The results in FIG. 11 show that there is no significant difference between sample 4A (less holes) as compared to sample 4B (more holes). FIG. 11 further shows samples 4C and 4D, which were similar to samples 4A and 4B respectively, but conducted without the mesh insert. Again, there is no significant difference between samples 4C and 4D (less holes vs. more holes), although there is a very significant difference seen between those samples that included the mesh insert (samples 4A-4B) as compared to those samples that did not include the mesh insert (samples 4C-4D). In particular, the peak temperature and total cooking time are significantly improved for samples 4A-4B (with the mesh insert) as compared to without the mesh insert (samples 4C-4D). As shown in FIG. 11, the temperature during the cooking time of samples 4C-4D averages less than about 400° F., which is undesirable. By comparison, samples 4A and 4B maintain a significantly higher temperature throughout the cooking phase, providing a far superior grilling experience. The time to reach 380° F., total cooking time (time over 380° F.), and peak temperature for samples 4A-4D are shown in Table 1 below.

TABLE 1

| | Visual Ash | Visual Ash | Time to | Time over | Peak |
|---|---|---|---|---|---|
| | at 10 min | at 20 min | 380° F. | 380° F. | Temperature |
| Sample | (%) | (%) | (min) | (min) | (° F.) |
| 4A | 20.2% | 81.3% | 11.4 | 57.8 | 561.2 |
| 4B | 19.9% | 75.4% | 11.4 | 52.6 | 585.4 |
| 4C | 22.0% | 47.2% | 12.5 | 4.75 | 445.4 |
| 4D | 26.0% | 54.0% | 11.4 | 14.4 | 488.8 |

Table 1 also shows the fraction of the charcoal that is ashed over, after 10 minutes, and after 20 minutes. As noted, Samples 4C and 4D (without the insert) show poor results in the time it takes them to become 50% or more ashed over, as well as the cooking time they provide at a temperature of over 380° F. The peak temperature reached for such samples is also significantly lower than for samples 4A-4B. By way of example, in an embodiment, the systems may provide a time over 380° F. of at least 30 minutes, or at least 40 minutes (e.g., from 30 to 80, or 30 to 60 minutes) for 3 to 3.5 lb of fuel (e.g., charcoal). Similarly, the systems may provide a peak temperature of at least 500° F., at least 525° F., or at least 550° F. (e.g., such as from 500° F. to 650° F., or from 500° F. to 600° F.). The additional curve shown in FIG. 11 is a comparative curve, shown for 3 lbs of KINGSFORD MATCH LIGHT charcoal, used without the system of the present invention.

### Example 5

Based on the results in Example 4 showing no significant difference between samples including more holes as compared to less holes, Example 5 was conducted to show the effect of including holes as compared to including no holes. Samples 5A and 5B of Example 5 each included a metallic foil tray, with a wire mesh insert similar to that of Example 4. Each included 3.5 pounds of KINGSFORD MATCH LIGHT charcoal briquets (pre-dosed with lighter fluid) loaded as a random pile into the tray, on top of the wire mesh insert including the undulating wave pattern. The foil tray of sample 5B was similar to sample 4A, including 18 holes, each about 1 cm in diameter. Sample 5A was similar, but without any such holes. The instant light briquets were ignited and evaluated. The results are shown in FIG. 12. While there are some differences seen between the burn curves of samples 5A and 5B, particularly during the ignition phase and the start of the cooking phase, the differences are not particularly significant, with no significant differences between time to cooking readiness, and total cooking time. The dashed line seen in FIG. 12 is at 380° F. The time to reach 380° F., total cooking time (time over 380° F.), and peak temperature for samples 5A-5B are shown in Table 2 below.

TABLE 2

| | Time to | Time over | Peak |
|---|---|---|---|
| | 380° F. | 380° F. | Temperature |
| Sample | (min) | (min) | (° F.) |
| 5A | 10.5 | 69.5 | 618.9 |
| 5B | 9.8 | 67.2 | 570.1 |

Without departing from the spirit and scope of the invention, one of ordinary skill can make various changes and modifications to the invention to adapt it to various usages and conditions. As such, these changes and modifications are properly, equitably, and intended to be, within the full range of equivalence of the following claims.

1. A self-contained fuel system for grilling, the system comprising:
an exterior tray formed from a non-combustible material, the tray defining an interior;
a mesh insert disposed within the interior of the tray, defining an air-flow portion below the mesh insert and a fuel portion above the mesh insert for supporting fuel, with the fuel suspended above the air-flow portion during use;
wherein the exterior tray and mesh insert are configured for use with a solid fuel, positioned in the fuel portion of the tray, supported on the mesh insert, during use.

2. The system of claim 1, further comprising a plurality of air flow holes provided through a lower portion of the exterior tray, configured to draw combustion air into the air-flow portion, below the mesh insert.

3. The system of claim 1, wherein the exterior tray does not include any air flow holes provided through a lower portion of the exterior tray.

4. The system of claim 1, wherein the solid fuel is provided pre-packaged with the exterior tray and mesh insert.

5. The system of claim 1, wherein the solid fuel is provided by a user separately from the exterior tray and mesh insert.

6. The system of claim 1, further comprising a kindling material pre-packaged with the exterior tray and mesh insert, for use within the air-flow portion.

7. The system of claim 1, wherein the exterior tray is formed from a metallic foil material, and the insert is formed of a flexible or bendable metallic mesh material, so that the entire system is disposable after a single use.

8. The system of claim 1, wherein the solid fuel comprises charcoal briquets.

9. The system of claim 8, wherein the charcoal briquets are pre-dosed during manufacture with lighter fluid.

10. The system of claim 1, wherein the mesh insert is in the form of a flexible or bendable metallic mesh insert having at least one of a curved surface, an accordion surface, or an undulating waved surface.

11. The system of claim 10, wherein the mesh insert having at least one of a curved surface, an accordion surface, or an undulating waved surface contacts a bottom interior surface of the exterior tray at at least one location, due to the curved surface, accordion surface, or undulating waved surface of the mesh insert.

12. The system of claim 1, wherein openings in the mesh insert are sufficiently small to support charcoal briquets on top of the mesh insert, and sufficiently large to allow ash generated from combustion of the charcoal briquets to fall through the openings in the mesh.

13. A self-contained, single-use disposable pre-packaged charcoal system for grilling, the system comprising:
an exterior tray formed from a non-combustible metal foil material, the tray defining an interior;
a non-combustible flexible or bendable metallic mesh insert disposed within the interior of the tray, the mesh insert providing a non-planar surface within the tray, defining an air-flow portion below the mesh insert and a charcoal portion above the mesh insert for supporting charcoal briquets, suspended above the air-flow portion;
wherein the exterior tray and mesh insert are configured for use with charcoal briquets, positioned in the fuel portion of the tray, supported on the mesh insert, during use.

14. The system of claim 13, wherein the exterior tray does not include any air flow holes provided through a lower portion of the exterior tray.

15. The system of claim 13, wherein the solid fuel is provided by a user separately from the exterior tray and mesh insert.

16. The system of claim 13, further comprising a plurality of fire-starter briquets provided with the exterior tray and mesh insert, for igniting the charcoal briquets.

17. The system of claim 13, further comprising a grate configured for placement over a top of the tray for grilling food on the grate.

18. A method for using a self-contained, disposable charcoal system for grilling, the method comprising:
providing a self-contained disposable charcoal system for grilling, the system comprising:
an exterior tray formed from a non-combustible metal foil material, the tray defining an interior;
a non-combustible flexible or bendable metallic mesh insert disposed within the interior of the tray, the mesh insert having at least one of a curved surface, an accordion surface, or an undulating waved surface, defining an air-flow portion below the mesh insert and a solid fuel portion above the mesh insert for supporting charcoal briquets or another solid fuel, suspended above the air-flow portion;
wherein the exterior tray and mesh insert are configured for use with charcoal briquets or another solid fuel, positioned in the fuel portion of the tray, supported on the mesh insert, during use;
igniting the charcoal briquets or other solid fuel; and
using the system for grilling;

19. The method of claim 18, wherein no handling of the charcoal briquets or other solid fuel is required by the user during the method, as they are pre-positioned during manufacture in the charcoal portion of the tray.

20. The method of claim 18, wherein the charcoal briquets are positioned in the charcoal portion as:
a random pile of briquets, with the briquets randomly oriented in the charcoal portion; or
an ordered arrangement of briquets, with the briquets oriented vertically, in rows, in the charcoal portion.
